(19) United States
(12) Patent Application Publication
(10) Pub. No.: US 2019/0216252 A1
(43) Pub. Date: Jul. 18, 2019

(54) MULTIFUNCTIONAL SLOW COOKER

(71) Applicant: Ningbo Jinyu Electric Appliance Co., Ltd., Yuyao (CN)

(72) Inventors: Junda Shi, Yuyao (CN); Zhongyu Shi, Yuyao (CN); Shukuo Liu, Yuyao (CN); Yinlu Wang, Yuyao (CN)

(21) Appl. No.: 15/927,416

(22) Filed: Mar. 21, 2018

(30) Foreign Application Priority Data
Jan. 17, 2018 (CN) 201820076002.2

(51) Int. Cl. A47J 27/00

(52) U.S. Cl. CPC A47J 27/004; F04D 29/083

(57) ABSTRACT

A multifunctional slow cooker includes a sealing gland, and a shell, an intermediate ring, a thermal insulation layer, an inner ring and a cooker body which are nested coaxially from outside to inside. A vacuum device is provided inside the sealing gland; a chassis is sheathed on a bottom end of the cooker body; a heating device and a refrigerating device are mounted on the chassis; and a power supply box is provided inside the shell. With the multifunctional slow cooker, food can also be vacuumed when it is heated or refrigerated, so that the shelf life of food is prolonged effectively.

### CROSS-REFERENCE TO RELATED APPLICATION

This application claims priority to Chinese Application No. 201820076002.2, filed Jan. 17, 2018, with a title of MULTIFUNCTIONAL SLOW COOKER. The above-mentioned patent application is incorporated herein by reference in its entirety.

### TECHNICAL FIELD

The present invention relates to the technical field of kitchen cooking equipment, and, in particular, to a slow cooker-type device.

### BACKGROUND

With the improvement of living standards, people's requirements on the functions of cookers are increasingly higher, and the types of cookers also become more complex and expensive. Because slow cookers save electric energy and can operate automatically within the preset time without any attention, slow cookers have increasingly become popular. Existing slow cookers generally have two modes, i.e., refrigeration and heating. However, in the modern family life, there is generally residual uncooked or cooked food, and such food will be wasted if being discarded but easily spoiled and rotted if being stored in cookers. Particularly, it is difficult to store some rare medicinal herbs (e.g., cordyceps sinensis, ginseng, or the like).

Therefore, a problem to be addressed currently in this field is to provide a multifunctional slow cooker which can realize refrigeration and heating and can effectively prolong the shelf life of food.

### SUMMARY

An objective of the present invention is to provide a multifunctional slow cooker to solve the problems in the prior art, which can effectively prolong the shelf life of food based on refrigeration and heating.

For this purpose, the present invention provides the following solutions.

In one embodiment, a multifunctional slow cooker includes a sealing gland. The slow cooker also includes a shell, an intermediate ring, a thermal insulation layer, an inner ring and a cooker body which are nested coaxially from outside to inside. A vacuuming device is provided inside the sealing gland; a chassis is sheathed on a bottom end of the cooker body; a heating device and a refrigerating device are mounted on the chassis; a power supply box is provided inside the shell; and, all the heating device, the refrigerating device and the vacuuming device are electrically connected to the power supply box.

In some embodiments, the sealing gland includes a panel, a gland plate and a liner from top to bottom, with a sealed cavity being formed by the gland plate and the liner; and, the vacuum device includes a vacuum pump and a solenoid valve, with the vacuum pump and the solenoid valve being arranged within the sealed cavity.

In still further embodiments, the heating device is a heating ring, and the heating ring is sheathed on the chassis and electrically connected to the power supply box.

In one aspect, a thermal insulation plate is provided at the bottom end of the chassis, and the refrigerating device is mounted on the chassis through the thermal insulation plate.

In another aspect, the refrigerating device includes a refrigerating sheet, a condenser and a fan successively arranged from top to bottom, and all the refrigerating sheet, the condenser and the fan are electrically connected to the power supply box.

In some embodiments, the thermal insulation plate is a metal plate.

In another aspect, the thermal insulation layer is polyurethane foam plastics.

In one aspect, a flange extending outward in a radial direction is provided at an upper end of the intermediate ring, and an upper surface of the flange contacts a lower surface of the sealing gland.

In a further aspect, a control chip for controlling the operation of the heating device, the refrigerating device and the vacuum device is provided inside the sealing gland.

Compared with the prior art conventional designs, the present invention provides the following advantages and technical effects. In the multifunctional slow cooker of these embodiments, because a vacuum device is provided inside the sealing gland and a heating device and a refrigerating device are mounted on the chassis, food can also be vacuumed when it is heated or refrigerated, so that the shelf life of the food is prolonged effectively. This improves the functionality of the slow cooker for end customers.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention.

FIG. 1 is an exploded perspective view of a multifunctional slow cooker according to one embodiment of the present invention; and

FIG. 2 is a front cross-sectional view of the multifunctional slow cooker of FIG. 1.

### DETAILED DESCRIPTION

The technical solutions in the embodiments of the present invention will be clearly and completely described below with reference to the accompanying drawings in the embodiments of the present invention. Apparently, the embodiments described herein are merely a part but not all the embodiments of the present invention. All other embodiments obtained by a person of ordinary skill in the art without paying any creative effort based on the embodiments in the present invention shall fall into the protection scope of the present invention.

An objective of the present invention is to provide a multifunctional slow cooker to solve the problems in the prior art, which can effectively prolong the shelf life of food based on refrigeration and heating.

To make the objectives, features and advantages of the present invention more obvious and comprehensible, the present invention will be further described below in detail by specific embodiments with reference to the accompanying drawings.

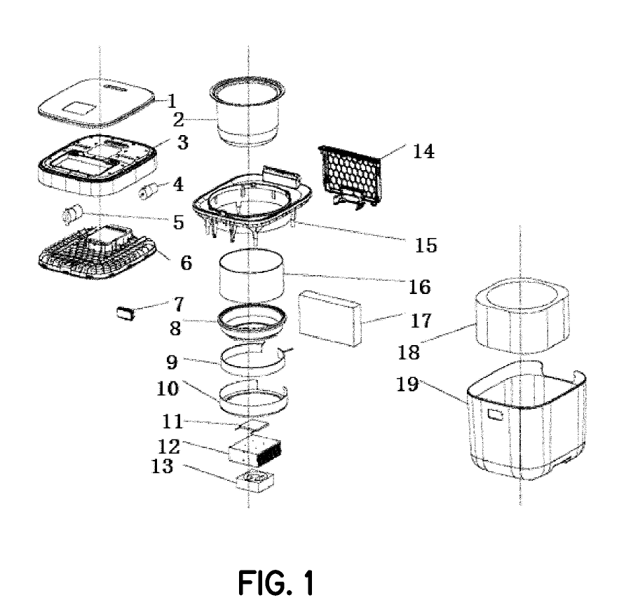

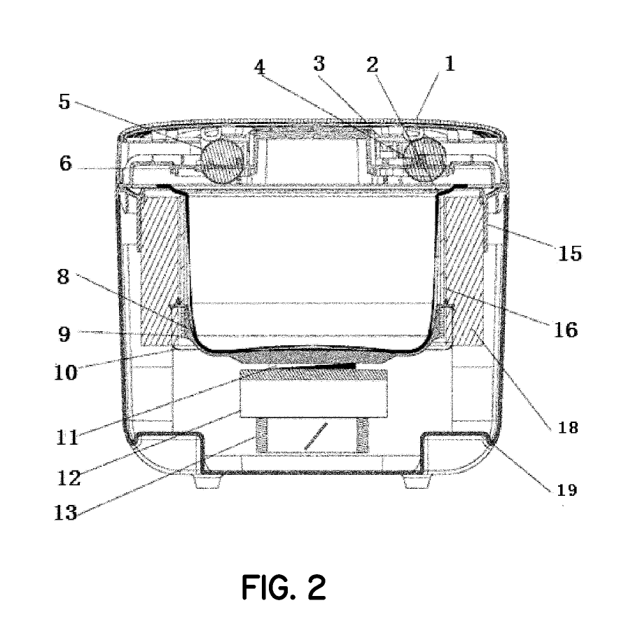

According to the embodiment shown in FIGS. 1 and 2, a multifunctional slow cooker includes a sealing gland, and a shell 19, an intermediate ring 15, a thermal insulation layer 18, an inner ring 16 and a cooker body 2 which are nested coaxially from outside to inside. An open button 7 for controlling the open and close of the sealing gland is provided on the shell 19. The sealing gland includes a panel 1, a gland plate 3 and a liner 6 from top to bottom. A sealed cavity is formed by the gland plate 3 and the liner 6. The vacuum device includes a vacuum pump 4 and a solenoid valve 5. Both the vacuum pump and the solenoid valve are arranged within the sealed cavity. A flange extending outward in a radial direction is provided at an upper end of the intermediate ring 15. An upper surface of the flange contacts a lower surface of the sealing gland. A chassis 8 is sheathed on a bottom end of the cooker body 2. A heating device and a refrigerating device are mounted on the chassis 8. A power supply box 17 and a circuit board bracket 14 are provided inside the shell 19. A control chip is further provided inside the sealing gland.

Each of the heating device, the refrigerating device, the vacuum device and the control chip is electrically connected to the power supply box 17, and the control chip controls the handover between a refrigeration mode, a heating mode and a vacuuming mode of the multifunctional slow cooker. With the multifunctional slow cooker, food can be vacuumed when it is heated or refrigerated, so that the shelf life of the food is prolonged effectively. Moreover, the refrigeration mode, the heating mode and the vacuuming mode of the multifunctional slow cooker can be combined freely to realize various functions.

To improve the heating effect, the heating device is a heating ring 9, and the heating ring 9 is electrically connected to the power supply box 17.

To improve the space utilization of the multifunctional slow cooker, the heating ring 9 is sheathed on the chassis 8, a metal plate 10 is provided at the bottom end of the chassis 8, and the refrigerating device is mounted on the chassis 8 through the metal plate 10.

To save cost and reduce the size, the refrigerating device includes a refrigerating sheet 11, a condenser 12 and a fan 13 which are arranged successively from top to bottom. All the refrigerating sheet 11, the condenser 12 and the fan 13 are electrically connected to the power supply box 17.

To improve the thermal insulation effect, the thermal insulation layer 18 is formed from polyurethane foam plastics.

In the multifunctional slow cooker provided by the present invention, the working principle is that cold or heat is transferred to the cooker body 2 by the refrigerating sheet 11 and the heating ring 9 and food is then refrigerated or heated by the cooker body 2. During the refrigeration process, heat on the refrigerating sheet 11 needs to be discharged from the shell 19 by the condenser 12, so that the refrigerating sheet 11 is prevented from burnout due to overheat. During the heating process, the metal chassis 8 is heated by the heating ring 9, and the chassis 8 transfers heat to the cooker to heat (slowly cook) food. Because the vacuum device is provided inside the sealing gland, after the sealing gland is closed, the cooker is vacuumed, so that the shelf life of food is effectively prolonged in a vacuum state.

The multifunctional slow cooker of the present invention can provide the following operational modes:
vacuuming;
vacuuming→refrigeration;
vacuuming→refrigeration→heating→heat preservation;
heating→refrigeration; and
heating→refrigeration→vacuuming.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the contents of this specification shall not be construed as a limitation to the invention.

### REFERENCE LIST

1: panel
2: cooker body
3: gland plate
4: vacuum pump
5: solenoid valve
6: liner
7: open button
8: chassis
9: heating ring
10: metal plate
11: refrigerating sheet
12: condenser
13: fan
14: circuit board bracket
15: intermediate ring
16: inner ring
17: power supply box
18: thermal insulation layer
19: shell

What is claimed is:

1. A multifunctional slow cooker, comprising:
a sealing gland; and
a shell, an intermediate ring, a thermal insulation layer, an inner ring and a cooker body, which are nested coaxially from outside to inside;
a vacuum device provided inside the sealing gland;
a chassis sheathed on a bottom end of the cooker body;
a heating device and a refrigerating device mounted on the chassis; and
a power supply box provided inside the shell,
wherein each of the heating device, the refrigerating device and the vacuum device is electrically connected to the power supply box.

2. The multifunctional slow cooker of claim 1, wherein the sealing gland comprises a panel, a gland plate and a liner from top to bottom, with a sealed cavity being formed by the gland plate and the liner; and the vacuum device comprises a vacuum pump and a solenoid valve, with the vacuum pump and the solenoid valve being arranged within the sealed cavity.

3. The multifunctional slow cooker of claim 1, wherein the heating device is a heating ring, and the heating ring is sheathed on the chassis and electrically connected to the power supply box.

4. The multifunctional slow cooker of claim 1, wherein a thermal insulation plate is provided at the bottom end of the chassis, and the refrigerating device is mounted on the chassis through the thermal insulation plate.

5. The multifunctional slow cooker of claim 4, wherein the refrigerating device comprises a refrigerating sheet, a condenser and a fan successively arranged from top to bottom, and each of the refrigerating sheet, the condenser and the fan is electrically connected to the power supply box.

6. The multifunctional slow cooker of claim 4, wherein the thermal insulation plate is a metal plate.

7. The multifunctional slow cooker of claim 1, wherein the thermal insulation layer is formed from polyurethane foam plastics.

8. The multifunctional slow cooker of claim 1, wherein a flange extending outward in a radial direction is provided at an upper end of the intermediate ring, and an upper surface of the flange contacts a lower surface of the sealing gland.

9. The multifunctional slow cooker of claim 1, wherein a control chip for controlling the operation of the heating device, the refrigerating device and the vacuum device is provided inside the sealing gland.
